(19) United States
(12) Patent Application Publication
(10) Pub. No.: US 2019/0215851 A1
(43) Pub. Date: Jul. 11, 2019

(54) DATA TRANSMISSION METHOD AND RELATED DEVICE

(71) Applicant: Huawei Technologies Co., Ltd., Shenzhen (CN)

(72) Inventors: Yanchun LI, Boulogne (FR); Yunbo LI, Shenzhen (CN)

(21) Appl. No.: 16/355,528

(22) Filed: Mar. 15, 2019

Related U.S. Application Data
(63) Continuation of application No. PCT/CN2017/103999, filed on Sep. 28, 2017.

(30) Foreign Application Priority Data
Sep. 30, 2016 (CN) 201610873170.X

(51) Int. Cl. H04W 72/12; H04W 72/14

(52) U.S. Cl. CPC H04W 72/1268; H04W 72/14; H04W 72/1289

(57) ABSTRACT

The present disclosure discloses a data transmission method, including: receiving, by a station (STA) on a first channel, a transmission indication sent by an access point (AP), where the transmission indication is used to indicate that a first frame is transmitted on a second channel, the transmission indication includes transmission information of the first frame, and the transmission information of the first frame includes at least one of a channel frequency, a channel bandwidth, spatial stream information, or a transmission time; and listening, by the STA, on the second channel according to the transmission indication, to receive the first frame sent by the AP. An embodiment of the present disclosure further provides a related device. Using embodiments of the present disclosure can improve resource utilization.

### CROSS-REFERENCE TO RELATED APPLICATIONS

This application is a continuation of International Application No. PCT/CN2017/103999, filed on Sep. 28, 2017, which claims priority to Chinese Patent Application No. 201610873170.X, filed on Sep. 30, 2016. The disclosures of the aforementioned applications are incorporated herein by reference in their entireties.

### TECHNICAL FIELD

The present disclosure relates to the field of communications technologies, and in particular, to a data transmission method and a related device.

### BACKGROUND

Wi-Fi technology is a short range wireless communications technology. A basic standard of the Wi-Fi technology is the 802.11 protocol stipulated by IEEE. A common structure of the Wi-Fi technology includes a central node, referred to as an access point (AP). The access point periodically sends a beacon frame to announce the existence of a network to the outside world. Another node, referred to as a station (STA), proactively sends a probe request, receives a probe response or passively receives the beacon frame and thereby knowing the existence of the AP, and performs message exchange with the AP to join the network of the AP. A network formed by the AP and the STA is referred to as a basic service set (BSS). The BSS includes an AP device and a STA device that establishes a connection with the AP.

In the existing Wi-Fi technology, data and control information are transmitted by using a same channel. The control information has a relatively high priority, but a size of data is usually far greater than a size of the control information. Consequently, the control information probably cannot be sent out in a timely manner. When an AP needs to allocate a channel resource to a station based on the control information, if the control information cannot be sent out in a timely manner, resources are wasted.

### SUMMARY

Embodiments of the present disclosure provide a data transmission method and a related device, to improve resource utilization.

According to a first aspect, a data transmission method is provided, including: receiving, by a STA on a first channel, a transmission indication from an AP, where the transmission indication is used to indicate that a first frame is transmitted on a second channel, the transmission indication includes transmission information of the first frame, and the transmission information of the first frame includes at least one of a STA identifier, a multicast identifier, a broadcast identifier, a channel frequency, a channel bandwidth, spatial stream information, or a transmission time; and the spatial stream information may include AP signal spatial direction information or a spatial stream quantity; and performing, by the STA, listening on the second channel according to the transmission indication, to receive the first frame from the AP. The first frame from the AP may include data of the STA. An information amount of control information is less than an information amount of data, and therefore the control information requires a relatively small bandwidth, and a relatively large quantity of orthogonal channels can be provided in a dense network, to isolate a collision on a control channel. It can be learned that transmitting the data and the control information on different channels can avoid a problem that the control information cannot be sent out in a timely manner, thereby improving resource utilization. In addition, when some channels are busy, the AP can indicate, by using the transmission indication, that the data is to be sent on an idle channel, further improving resource utilization.

In one embodiment, when the STA performs listening on the first channel, the STA may turn off listening on the second channel, so as to reduce power consumed on the second channel. The STA may enable an antenna and an RF chain (e.g., a power amplifier (PA), a low noise amplifier (LNA), an analog-to-digital converter (ADC), a digital-to-analog converter (DAC), or the like) based on the spatial stream information. For example, if the AP indicates two spatial streams to the STA, the STA enables two RF chains, and no more than two spatial streams are from the AP to the STA on the second channel.

Embodiments of the present disclosure may be further applied to a system that requires beamforming. The first frame may include AP transmit sector sweep information, and correspondingly, a transmission time in the transmission indication includes at least one piece of information of a starting time, duration, or an end time of AP transmit sector sweep. The transmission indication may include a quantity of sectors in the AP transmit sector sweep, and/or AP receive RF chain quantity information.

In one embodiment, the transmission indication may include an AP-probed STA transmit sector sweep time. The transmission indication may include a field to indicate that the time is used for an AP transmit sector sweep or the AP-probed STA transmit sector sweep time. After the AP detects a STA transmit sector sweep frame, the AP sends a sector sweep feedback frame. The AP may transmit the sector sweep feedback frame by using the first channel. The sector sweep feedback frame may carry best quality sector information, such as a sector identifier/number. The transmit sector sweep is that a sender (e.g., the AP or the STA) sends a beamforming training signal in one or more directions. The transmission indication may include a quantity of sectors in AP transmit sector sweep, and/or AP receive RF chain quantity information. In the foregoing manner, sending may be performed by using the first channel before a forward link and a reverse link are established on the second channel, so as to reduce a sending time.

In one embodiment, when the first channel and the second channel are a same channel, and the first frame is data, duration for transmitting the first frame on the second channel is less than or equal to specified duration. To be specific, the data and the control information can be transmitted on a same channel, but to avoid that the data occupies the channel for a very long time, the duration for transmitting the data on the channel is limited and should not exceed the specified duration. This can avoid a problem that the control information cannot be sent out in a timely manner, thereby improving resource utilization.

In one embodiment, before the receiving, by a STA on a first channel, a transmission indication from an AP, the STA performs listening on a third channel, to receive a second frame from the AP, where the second frame includes an indication of the first channel, the indication of the first channel includes characteristic information of the first channel, and the characteristic information of the first channel includes at least one of frequency of the first channel, bandwidth of the first channel, a sending time, a modulation scheme, a frame format, a protocol version, or a time period of the first channel; and the receiving, by a STA on a first channel, a transmission indication from an AP is specifically: receiving, by the STA on the first channel based on the characteristic information of the first channel, the transmission indication from the AP. It can be learned that the STA can perform control channel search based on the characteristic information of the control channel. This can narrow a control channel search range, and reduces a large amount of time and power that the STA spends on scanning and searching a channel. The AP may use one or more first channels with different frequencies. To improve reliability, the AP may use a plurality of first channels, and correspondingly, the second frame sent by the AP may include an indication of the plurality of first channels. The third channel may be a channel the same as or different from the second channel.

In one embodiment, the first frame is a trigger frame, the trigger frame includes an uplink transmission parameter, and after the performing, by the STA, listening on the second channel according to the transmission indication, to receive the first frame from the AP, the STA performs uplink transmission based on the uplink transmission parameter. The uplink transmission parameter includes at least one of a frequency, a bandwidth, a subchannel, a subcarrier, a time, a modulation and coding scheme, a multiple-input multiple-output (MIMO) spatial stream, or pilot resource information.

In one embodiment, before the receiving, by a STA on a first channel, a transmission indication from an AP, the STA performs listening on the second channel, to receive a third frame from the AP; and the STA sends a fourth frame to the AP on the second channel corresponding to the third frame. The fourth frame includes a sending mode for sending the transmission indication, and the sending mode of the transmission indication is used by the AP to send the transmission indication. The sending mode of the transmission indication includes: sending the transmission indication on the first channel and/or sending the transmission indication on the second channel.

In one embodiment, the first frame includes transmission information of a fifth frame, the transmission information of the fifth frame includes at least one of a channel frequency, a channel bandwidth, spatial stream information, or a transmission time, and after the performing, by the STA, listening on the second channel according to the transmission indication, to receive the first frame from the AP, the STA performs listening on the second channel based on the transmission information of the fifth frame, to obtain the fifth frame.

In one embodiment, the transmission indication further includes a STA identifier (ID), a STA group ID, channel frequency information, or a channel number, and the performing, by the STA, listening on the second channel according to the transmission indication includes: when the transmission indication meets a preset condition, performing, by the STA, listening on the second channel according to the transmission indication.

In one embodiment, before the performing, by the STA, listening on the second channel according to the transmission indication, the STA performs listening on the second channel, to receive a sixth frame from the AP, where the sixth frame is used to query a channel bandwidth available to the STA; and the STA sends a seventh frame to the AP on the second channel corresponding to the sixth frame, where the seventh frame is used to return the channel bandwidth available to the STA, so that the AP sends the first frame on the channel bandwidth available to the STA.

According to a second aspect, an embodiment provides a data transmission method, including: sending, by an AP, a transmission indication on a first channel, where the transmission indication is used to indicate that a first frame is transmitted on a second channel, the transmission indication includes transmission information of the first frame, and the transmission information of the first frame includes at least one of a channel frequency, a channel bandwidth, spatial stream information, or a transmission time; and sending, by the AP, the first frame on the second channel according to the transmission indication. It can be learned that transmitting data and control information on different channels can avoid a problem that the control information cannot be sent out in a timely manner, thereby improving resource utilization. In addition, when some channels are busy, the AP can indicate, by using the transmission indication, that the data is to be sent on an idle channel, further improving resource utilization.

In one embodiment, when the first channel and the second channel are a same channel, and the first frame is data, duration for transmitting the first frame on the second channel is less than or equal to specified duration. To be specific, the data and the control information can be transmitted on a same channel, but to avoid that the data occupies the channel for a very long time, the duration for transmitting the data on the channel is limited and should not exceed the specified duration. This can avoid a problem that the control information cannot be sent out in a timely manner, thereby improving resource utilization.

In one embodiment, before the sending, by an AP, a transmission indication on a first channel, the AP sends a second frame on a third channel, where the second frame includes an indication of the first channel, the indication of the first channel includes characteristic information of the first channel, and the characteristic information of the first channel includes at least one of frequency of the first channel, bandwidth of the first channel, a sending time, a modulation scheme, a frame format, a protocol version, or a time period of the first channel; and the sending, by an AP, a transmission indication on a first channel includes: sending, by the AP, the transmission indication on the first channel based on the characteristic information of the first channel.

In one embodiment, the first frame is a trigger frame, the trigger frame includes an uplink transmission parameter, and the uplink transmission parameter is used to instruct the STA to perform uplink transmission based on the uplink transmission parameter. The uplink transmission parameter includes at least one of a frequency, a bandwidth, a subchannel, a subcarrier, a time, a modulation and coding scheme, a MIMO spatial stream, or pilot resource information.

In one embodiment, before the sending, by an AP, a transmission indication on a first channel, the AP sends a third frame on the second channel; and the AP receives a fourth frame from the STA on the second channel corresponding to the third frame, where the fourth frame includes a sending mode for sending the transmission indication, and the sending mode of the transmission indication includes: sending the transmission indication on the first channel and/or sending the transmission indication on the second channel; and the sending, by an AP, a transmission indication on a first channel includes: sending the transmission indication on the first channel based on the sending mode of the transmission indication.

In one embodiment, the first frame includes transmission information of a fifth frame, the transmission information of the fifth frame includes at least one of a channel frequency, a channel bandwidth, spatial stream information, or a transmission time, and after the sending, by the AP, the first frame on the second channel according to the transmission indication, the AP sends the fifth frame on the second channel based on the transmission information of the fifth frame.

In one embodiment, before the sending, by the AP, the first frame on the second channel according to the transmission indication, the method further includes: sending, by the AP, a sixth frame on the second channel, where the sixth frame is used to query a channel bandwidth available to the STA; receiving, by the AP, a seventh frame from the STA to the AP on the second channel corresponding to the sixth frame, where the seventh frame is used to return the channel bandwidth available to the STA; and the sending, by the AP, the first frame on the second channel according to the transmission indication includes: sending, by the AP according to the transmission indication, the first frame on the channel bandwidth available to the STA.

In one embodiment, the first channel and the second channel are a same channel, and the method further includes: when the AP detects, on a channel used by the AP, a frame sent by another AP, restricting, by the AP, a type of a frame that is sent on the channel used by the AP. It can be learned that restricting the type of the frame that is sent on the channel used by the AP can further avoid a problem that the control information cannot be sent out in a timely manner.

In one embodiment, that duration for transmitting the first frame on the second channel is less than or equal to specified duration includes: duration for occupying the second channel by the first frame in a single physical transmission is less than or equal to first specified duration, and duration for occupying the second channel by the first frame in a single transmission is less than or equal to second specified duration. The second specified duration is greater than the first specified duration.

In one embodiment, a first frequency sub-band of the channel used by the AP and a second frequency sub-band of a channel used by the another AP belong to a same frequency band range.

According to a third aspect, an embodiment provides a station, including modules configured to execute the method in the first aspect.

According to a fourth aspect, an embodiment provides an access point, including modules configured to execute the method in the second aspect.

According to a fifth aspect, an embodiment provides a station. The station includes a processor, and the processor is configured to support the station in performing a corresponding function in the data transmission method provided in the first aspect. The station may further include a memory, and the memory is configured to be coupled to the processor and store program instructions and data that are necessary for the station. The station may further include a communications interface, configured for this network element to communicate with another device or communications network.

According to a sixth aspect, an embodiment provides an access point. The access point includes a processor, and the processor is configured to support the access point in performing a corresponding function in the data transmission method provided in the second aspect. The access point may further include a memory, and the memory is configured to be coupled to the processor and store program instructions and data that are necessary for the access point. The access point may further include a communications interface configured for this network element to communicate with another device or communications network.

According to a seventh aspect, an embodiment provides a computer storage medium, configured to store computer software instructions used by the station provided in the fifth aspect. The computer software instruction includes a program designed for executing the foregoing aspect.

According to an eighth aspect, an embodiment provides a computer storage medium configured to store computer software instructions used by the access point provided in the sixth aspect. The computer software instructions include a program designed for executing the foregoing aspect.

These or other aspects are more concise and comprehensible in descriptions of the following embodiments.

### BRIEF DESCRIPTION OF DRAWINGS

To describe the technical solutions in the embodiments of the present disclosure more clearly, the following briefly describes the accompanying drawings required for describing the embodiments or the prior art. Apparently, the accompanying drawings in the following description show merely some embodiments of the present disclosure, and a person of ordinary skill in the art may still derive other drawings from these accompanying drawings without creative efforts.

FIG. 1 is a schematic diagram of a communications system according to one embodiment;

FIG. 2 is a schematic flow chart of a data transmission method according to one embodiment;

FIG. 3 is a schematic diagram of a channel according to one embodiment;

FIG. 4 is a schematic flow chart of a data transmission method according to one embodiment;

FIG. 5 is a schematic structural diagram of a station according to one embodiment;

FIG. 6 is a schematic structural diagram of an access point according to one embodiment; and

FIG. 7 is a schematic structural diagram of a computer device according to one embodiment.

### DESCRIPTION OF EMBODIMENTS

To make persons skilled in the art understand the solutions in the present disclosure better, the following clearly describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by persons of ordinary skill in the art based on the embodiments of the present disclosure without creative efforts shall fall in the protection scope of the present disclosure.

Details are separately described in the following.

In the specification, claims, and accompanying drawings of the present disclosure, the terms “first”, “second”, “third”, “fourth”, and so on are intended to distinguish between different objects but do not indicate a particular order. Moreover, the terms “including”, “comprising”, and any other variant thereof, are intended to cover a non-exclusive inclusion. For example, a process, a method, a system, a product, or a device that includes a series of steps or units is not limited to the listed steps or units, but in some embodiments further includes an unlisted step or unit, or in some embodiments further includes another inherent step or unit of the process, the method, the product, or the device.

“An embodiment” mentioned in the specification indicates that a particular characteristic, structure or property that is related to the embodiment may be included in at least one embodiment of the present disclosure. The phrase occurred at different locations in the specification does not necessarily refer to a same embodiment, nor an independent or alternate embodiment exclusive of another embodiment. A person skilled in the art understands, in explicit and implicit manners, that an embodiment described in this disclosure may be combined with another embodiment.

In the following, some terms in this disclosure are described, so as to help a person skilled in the art have a better understanding.

1. A control channel (CCH) is a channel used to provide a data reception or sending indication. A data channel is a channel used to carry data.

2. A STA is a terminal connected to a wireless network, for example, a handheld device or an in-vehicle device with a wireless connection function. A common terminal includes, for example, a mobile phone, a tablet computer, a notebook computer, a palmtop computer, a mobile Internet device (MID), or a wearable device such as a smartwatch, a smart band, or a pedometer.

3. An AP is usually translated into a “wireless access point” or a “bridge”. The AP mainly serves as a bridge between a wireless station and a wired local area network at a Media Access Control (MAC) layer.

4. A channel frequency is a frequency of a signal that passes through the channel.

5. A channel bandwidth is a signal spectrum width, to be specific, a difference between a highest signal frequency component and a lowest signal frequency component.

6. A spatial stream is a signal generated when a signal transmitted by radio is reflected in a multiple-input multiple-output (MIMO) technology.

7. A beacon frame is a frame used to send a beacon by a primary coordinator in a personal area network (PAN).

8. A trigger frame is a frame used when a primary node queries, at a frame interval, whether a signal of each secondary node changes.

9. “A plurality of” means two or more. The term “and/or” describes an association relationship between associated objects and represents that three relationships may exist. For example, A and/or B may represent the following three cases: Only A exists, both A and B exist, or only B exists. The character “/” generally indicates an “or” relationship between the associated objects.

The following describes the embodiments of this disclosure with reference to the accompanying drawings.

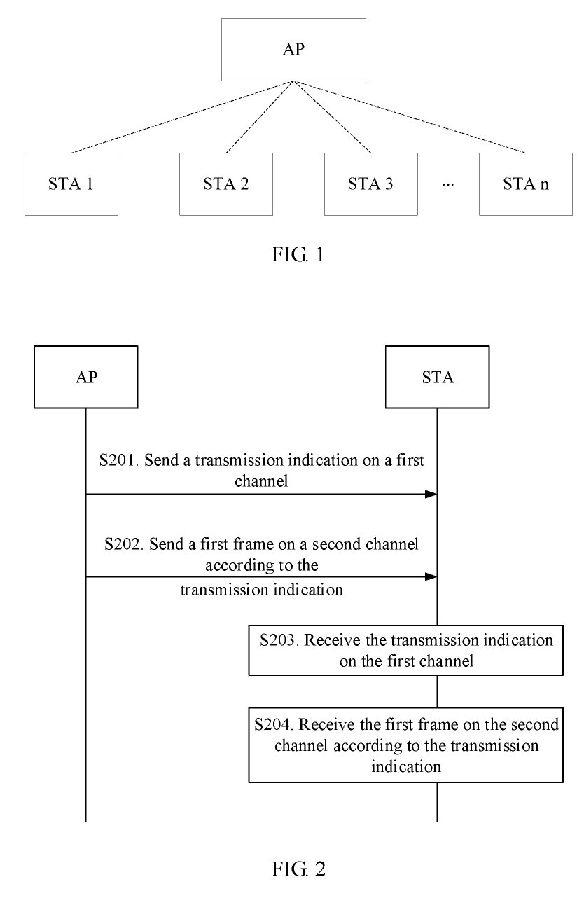

Referring to FIG. 1, FIG. 1 is a schematic diagram of a communications system disclosed according to one embodiment. The communications system shown in FIG. 1 includes a plurality of STAs (such as STA 1, STA 2, STA 3, . . . , and STA n) and an AP. The AP sends a transmission indication on a first channel. The transmission indication is used to indicate that a first frame is transmitted on a second channel. The transmission indication includes transmission information of the first frame. The transmission information of the first frame includes at least one of a channel frequency, a channel bandwidth, spatial stream information, or a transmission time. Then, the AP sends the first frame on the second channel according to the transmission indication. Later, the STA receives, on a first channel, the transmission indication from the AP, and performs listening on the second channel according to the transmission indication, to receive the first frame from the AP. It can be learned that transmitting data and control information on different channels can avoid a problem that the control information cannot be sent out in a timely manner, thereby improving resource utilization. In addition, when some channels are busy, the AP can indicate, by using the transmission indication, that the data is to be sent on an idle channel, further improving resource utilization.

Referring to FIG. 2, FIG. 2 is a schematic flow chart of a data transmission method according to one embodiment. The method includes the following steps.

S201. An AP sends a transmission indication on a first channel, where the transmission indication is used to indicate that a first frame is transmitted on a second channel, the transmission indication includes transmission information of the first frame, and the transmission information of the first frame includes at least one of a channel frequency, a channel bandwidth, spatial stream information, or a transmission time. The spatial stream information may include AP signal spatial direction information or a spatial stream quantity. In one embodiment, the transmission indication further includes at least one of a STA identifier, a multicast identifier, or a broadcast identifier.

S202. The AP sends the first frame on the second channel according to the transmission indication.

S203. A STA receives, on the first channel, the transmission indication from the AP.

S204. The STA performs listening on the second channel according to the transmission indication, to receive the first frame from the AP.

It should be noted that the first channel and the second channel may be different channels, for example, the first channel is a control channel and the second channel is a data channel; or the first channel and the second channel may be a same channel, for example, both the first channel and the second channel are a control channel or both the first channel and the second channel are a data channel.

In one embodiment, the first frame includes a data frame, a management frame, a control frame, or a trigger frame.

For example, when the transmission indication includes a channel frequency, the STA performs listening on a channel including the channel frequency, to receive the first frame from the AP; when the transmission indication includes a channel bandwidth, the STA sets a receive/transmit channel bandwidth to be greater than or equal to the bandwidth, to receive the first frame from the AP; or when the transmission indication includes spatial stream information, the STA uses a receive/transmit RF chain whose quantity is greater than or equal to that of spatial streams included in the spatial stream information, to receive the first frame from the AP.

In one embodiment, when the STA performs listening on the first channel, the STA may turn off listening on the second channel, so as to reduce power consumed on the second channel. In one embodiment, the STA may enable an antenna and an RF chain (e.g., a power amplifier (PA), a low noise amplifier (LNA), an analog-to-digital converter (ADC), a digital-to-analog converter (DAC), or the like) based on the spatial stream information. For example, if the AP indicates two spatial streams to the STA, the STA enables two RF chains, and no more than two spatial streams are from the AP to the STA on the second channel.

Embodiments of the disclosure may be further applied to a system that requires beamforming. The first frame may include AP transmit sector sweep information, and correspondingly, a transmission time in the transmission indication includes at least one piece of information of a starting time, duration, or an end time of AP transmit sector sweep. The transmission indication may include a quantity of sectors in the AP transmit sector sweep, and/or AP receive RF chain quantity information.

In one embodiment, the transmission indication may include an AP-probed STA transmit sector sweep time. The transmission indication may include a field to indicate that the time is used for an AP transmit sector sweep or the AP-probed STA transmit sector sweep time. After the AP detects a STA transmit sector sweep, the AP sends a sector sweep feedback. The AP may transmit the sector sweep feedback by using the first channel. The sector sweep feedback may carry best quality sector information, such as a sector identifier/number. The transmit sector sweep is that a sender (e.g., the AP or the STA) sends a beamforming training signal in one or more directions. The transmission indication may include a quantity of sectors in AP transmit sector sweep, and/or AP receive RF chain quantity information. In the foregoing manner, sending may be performed by using the first channel before a forward link and a reverse link are established on the second channel, so as to reduce a sending time.

In one embodiment, when the first channel and the second channel are a same channel, and the first frame is data, duration for transmitting the first frame on the second channel is less than or equal to specified duration. To be specific, the data and the control information can be transmitted on a same channel, but to avoid that the data occupies the channel for a very long time, the duration for transmitting the data on the channel needs to be limited and should not exceed the specified duration. This can avoid a problem that the control information cannot be sent out in a timely manner, thereby improving resource utilization.

In one embodiment, before step S201 in which the AP sends the transmission indication on the first channel, the method further includes: The AP sends a second frame on a third channel, where the second frame includes an indication of the first channel, the indication of the first channel includes characteristic information of the first channel, and the characteristic information of the first channel includes at least one of frequency of the first channel, bandwidth of the first channel, a sending time, a modulation scheme, a frame format, a protocol version, or a time period of the first channel; the AP sends the transmission indication on the first channel based on the characteristic information of the first channel; and subsequently, the STA performs listening on the third channel, to receive the second frame from the AP, and the STA receives, on the first channel based on the characteristic information of the first channel, the transmission indication from the AP.

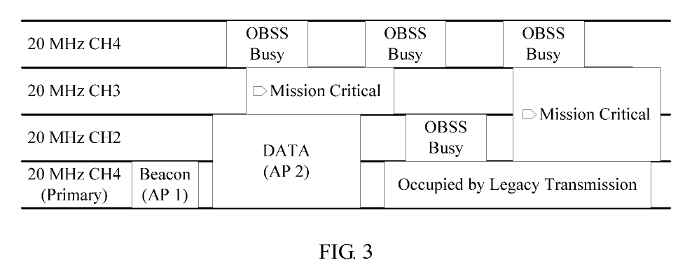

In one embodiment, the third channel may be or may not be a same channel as the second channel, though no limitation is imposed. For example, as shown in FIG. 3, the first frame may be transmitted on a 20 MHz CH3, the second frame may be transmitted on a 20 MHz CH1, or both the first frame and the second frame are transmitted on a 20 MHz CH3.

For example, it is assumed that the first channel is a control channel, the second channel is a data channel, and the second frame is a beacon frame. The control channel occupies a small bandwidth, and therefore more control channels are available to be used as control channels of the AP. In frequency domain, the STA can directly search for a control channel. In this case, the STA needs to perform a large quantity of switching operations between channels for scanning and searching, and thereby a large amount of time and power may be consumed. In this solution, the STA may first perform data channel search, to receive a beacon frame from the AP on a data channel. The beacon frame includes an indication of a control channel, and the indication of the control channel includes characteristic information of the control channel. The STA may perform control channel search based on the characteristic information of the control channel. This can narrow a control channel search range, and reduces a large amount of time and power that the STA spends on scanning and searching a channel.

The AP may use one or more first channels with different frequencies. To improve reliability, the AP may use a plurality of first channels, and correspondingly, the second frame from the AP may include an indication of the plurality of first channels. The third channel may be a channel the same as or different from the second channel.

In one embodiment, the first frame is a trigger frame, the trigger frame includes an uplink transmission parameter, and after step S204 in which the STA performs listening on the second channel according to the transmission indication, to receive the first frame from the AP, the STA performs uplink transmission based on the uplink transmission parameter. The uplink transmission parameter includes at least one of a frequency, a bandwidth, a subchannel, a subcarrier, a time, a modulation and coding scheme, a MIMO spatial stream, or pilot resource information.

In one embodiment, before step S201 in which the AP sends the transmission indication on the first channel, the AP sends a third frame on the second channel, and the STA performs listening on the second channel, to receive the third frame from the AP; and the STA sends a fourth frame to the AP on the second channel corresponding to the third frame, the AP receives the fourth frame from the STA on the second channel corresponding to the third frame, and the AP sends the transmission indication on the first channel based on a sending mode of the transmission indication. The fourth frame includes the sending mode for sending the transmission indication. The sending mode of the transmission indication includes: sending the transmission indication on the first channel and/or sending the transmission indication on the second channel.

The sending mode of the transmission indication that the STA can support includes at least two of the following plurality of modes: Sending mode 1: The STA may depend only on a data channel to send the transmission indication and do not use a control channel, that is, the AP sends the transmission indication only on the data channel; sending mode 2: The STA needs to depend on a control channel to send the transmission indication, that is, the AP sends the transmission indication only on the control channel; sending mode 3: The AP may send the transmission indication simultaneously on a data channel and a control channel, that is, the AP may send the transmission indication on the data channel at the same time when sending the transmission indication on the control channel.

For example, it is assumed that the second channel is a data channel. During initial access, the STA performs listening on the data channel, to receive the third frame from the AP (where the third frame may be, for example, a beacon frame or a probe response frame). Then, the STA sends the fourth frame (where the fourth frame may be, for example, an association request frame or a reply frame in response to the third frame), and the STA indicates, in the fourth frame, the sending mode of the transmission indication supported by the STA. The AP performs data transmission for the STA based on the sending mode of the transmission indication indicated by the STA.

In one embodiment, the first frame includes transmission information of a fifth frame, the transmission information of the fifth frame includes at least one of a channel frequency, a channel bandwidth, spatial stream information, or a transmission time, and after step S202 in which the AP sends the first frame on the second channel according to the transmission indication, the AP sends the fifth frame on the second channel based on the transmission information of the fifth frame, and the STA performs listening on the second channel based on the transmission information of the fifth frame, to obtain the fifth frame.

Further, the AP may add network allocation vector (NAV) information to the first frame or a frame earlier than the first frame.

In one embodiment, the transmission indication further includes a STA ID, a STA group ID, channel frequency information, or a channel number, or a specific implementation of performing, by the STA, listening on the second channel according to the transmission indication includes: when the transmission indication meets a preset condition, performing, by the STA, listening on the second channel according to the transmission indication.

In one embodiment, the preset condition may be: An ID of the STA is the same as the STA ID in the the transmission indication; or the STA belongs to a STA group corresponding to the STA group ID in the the transmission indication; or a preset channel of the STA is the same as a channel pre-negotiated by the STA and the AP; or an indicated channel/bandwidth includes a preset channel of the STA and a channel/bandwidth pre-negotiated by the STA and the AP.

In one embodiment, before step S202 in which the AP sends the first frame on the second channel according to the transmission indication, the AP sends a sixth frame on the second channel, where the sixth frame is used to query a channel bandwidth available to the STA; the STA performs listening on the second channel, to receive the sixth frame from the AP; the STA sends a seventh frame to the AP on the second channel corresponding to the sixth frame, where the seventh frame is used to return the channel bandwidth available to the STA; the AP receives the seventh frame from the STA to the AP on the second channel corresponding to the sixth frame; and the AP sends, according to the transmission indication, the first frame on the channel bandwidth available to the STA.

For example, it is assumed that the first channel is a control channel, and the second channel is a data channel. The AP first sends the transmission indication on the control channel, and then the AP sends the sixth frame on the data channel. After the AP receives the seventh frame from the STA on the data channel corresponding to the sixth frame, the AP sends the first frame on the data channel. The seventh frame may be an acknowledgement that the STA receives the sixth frame, or may be a response of the sixth frame. For example, the AP queries, in the sixth frame, a channel bandwidth available to a user, and the STA returns, in the seventh frame, the channel bandwidth available to the STA, so that the AP transmits data to the STA on a channel available to the STA or on a better channel. When the STA receives the transmission indication from the AP, the STA first determines whether content of the transmission indication meets the preset condition, and if the content of the transmission indication meets the preset condition, the STA performs listening on the data channel, to receive the sixth frame from the AP. For a specific implementation of determining, by the STA, whether the content of the transmission indication meets the preset condition, reference may be made to the foregoing method description, and details are not described herein again.

In one embodiment, the first channel and the second channel are a same channel, and when the AP detects, on a channel used by the AP, a frame from another AP, the AP restricts a type of a frame that is sent on the channel used by the AP.

For example, it is assumed that both the first channel and the second channel are a control channel. When the AP detects, on a control channel used by the AP, a frame sent by another AP, the AP restricts a type of the frame that is sent by the other AP on the control channel used by the AP. For example, the AP may restrict that the other AP performs only control frame transmission on the control channel, or restrict that the other AP performs transmission of only a control frame and a specified type of data packet on the control channel.

In one embodiment, the first channel and the second channel are a same channel, and that duration for transmitting the first frame on the second channel is less than or equal to specified duration includes: duration for occupying the second channel by the first frame in a single physical transmission is less than or equal to first specified duration, and duration for occupying the second channel by the first frame in a single transmission is less than or equal to second specified duration. The second specified duration is greater than the first specified duration.

The single physical transmission means that one physical layer protocol data unit (PPDU) is transmitted. The single transmission means one transmission opportunity (TXOP). A plurality of PPDUs can be sent during one TXOP.

When the second specified duration is greater than the first specified duration, if an overlapping basic service set (OBSS) has higher priority of data to be transmitted, sending a plurality of PPDUs during one TXOP may be interrupted. For example, there should be an interval between two PPDU transmissions, and the interval may include one or more listening timeslots for listening. A quantity of the listening timeslots is a listening timeslot quantity 2. A quantity of listening timeslots before single channel occupation is a listening timeslot quantity 1. The listening timeslot quantity 2 is less than the listening timeslot quantity 1 or an expected value of the listening timeslot quantity 1. The high priority of data and a control frame of the OBSS have a short waiting time and are sent earlier than a current BSS. The current BSS gives up the TXOP if the current BSS finds that the OBSS performs sending, causing an interruption.

The second specified duration is greater than the first specified duration. Although a stated total time of channel occupation is longer, high priority of data will not wait a very long time because transmission of a plurality of PPDUs in a TXOP can be interrupted.

In one embodiment, a first frequency sub-band of the channel used by the AP and a second frequency sub-band of a channel used by the another AP belong to a same frequency band range.

For example, if the AP finds that the other AP is using a 2 MHz channel in a first 20 MHz (2420 to 2440 MHz) frequency band to transmit control information, the AP may use another 2 MHz channel in the frequency band to transmit control information. Frequencies used by the AP and the other AP may be different, to avoid mutual interference. A data bandwidth may be 20 MHz. If the AP and the other AP choose a frequency band randomly, the 2 MHz channels used by the AP and the other AP disperse, and many frequency bands that may be used as a complete data channel are partially occupied, thereby resulting in low channel utilization.

In one embodiment, the AP may indicate one or more control channels to a plurality of STAs. The AP may indicate different control channels to the plurality of STAs. When there are a plurality of control channels, control channel characteristic information used for these control channels differs. For example, frequency information of these control channels is different. Therefore, after the AP indicates, to the STA 1, frequency information 1 of a control channel, and the AP indicates, to the STA 2, frequency information 2 of a control channel, when the AP sends a packet on a control channel with the frequency information 1, the AP does not trigger the STA 2 to receive the packet. This can save STA power.

In can be learned that in this embodiment, the STA receives, on the first channel, the transmission indication from the AP, where the transmission indication is used to indicate that the first frame is transmitted on the second channel, the transmission indication includes the transmission information of the first frame, and the transmission information of the first frame includes at least one of a channel frequency, a channel bandwidth, spatial stream information, or a transmission time; and the STA performs listening on the second channel according to the transmission indication, to receive the first frame from the AP. It can be learned that transmitting data and control information on different channels can avoid a problem that the control information cannot be sent out in a timely manner, thereby improving resource utilization. In addition, when some channels are busy, the AP can indicate, by using the transmission indication, that the data is to be sent on an idle channel, thereby further improving resource utilization.

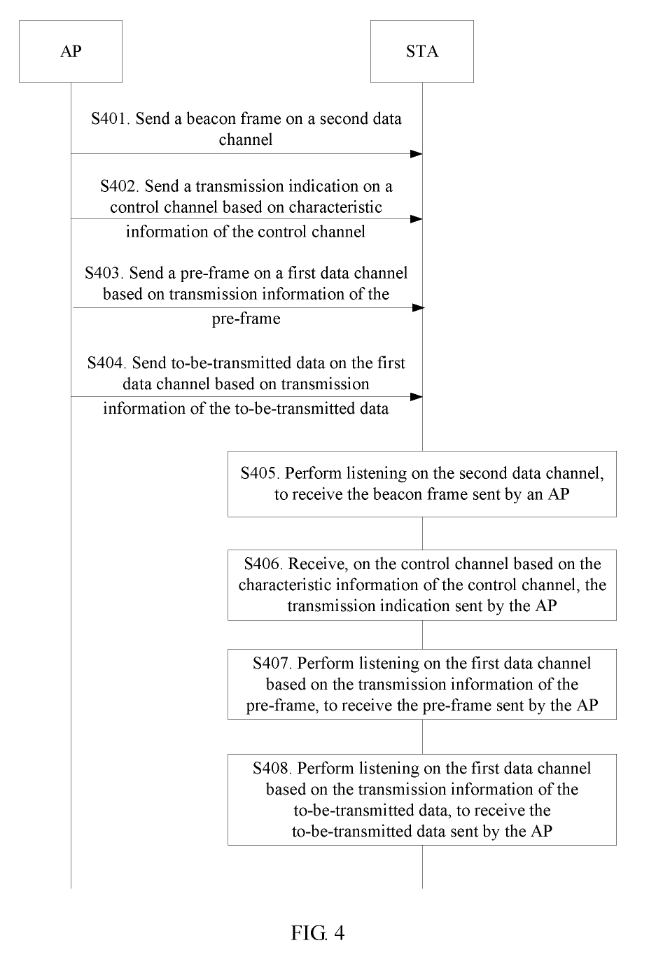

An embodiment of the present disclosure further provides another more detailed method procedure, in which the first channel is a control channel, the second channel is a first data channel, and the third channel is a second data channel. As shown in FIG. 3, the first data channel may be a 20 MHz CH3, the second data channel may be a 20 MHz CH3, the second frame is a beacon frame, the fifth frame is to-be-transmitted data, and the first frame is a pre-frame earlier than the fifth frame. As shown in FIG. 4, the method procedure includes the following steps.

S401. An AP sends a beacon frame on a second data channel, where the beacon frame comprises an indication of a control channel, the indication of the control channel includes characteristic information of the control channel, and the characteristic information of the control channel includes at least one of frequency information, bandwidth information, a sending time, a modulation scheme, a frame format, a protocol version, or a time period of the control channel.

S402. The AP sends a transmission indication on the control channel based on the characteristic information of the control channel, where the transmission indication is used to indicate that a first frame is transmitted on a second channel, the transmission indication includes transmission information of the first frame, and the transmission information of the first frame includes at least one of a channel frequency, a channel bandwidth, spatial stream information, or a transmission time.

S403. The AP sends the pre-frame on the first data channel based on the transmission information of the pre-frame, where the pre-frame includes transmission information of to-be-transmitted data, and the transmission information of the to-be-transmitted data includes at least one of a channel frequency, a channel bandwidth, spatial stream information, or a transmission time.

S404. The AP sends the to-be-transmitted data on the first data channel based on the transmission information of the to-be-transmitted data.

S405. A STA performs listening on the second data channel, to receive the beacon frame from the AP.

S406. The STA receives, on the control channel based on the characteristic information of the control channel, the transmission indication from the AP.

S407. The STA performs listening on the first data channel based on the transmission information of the pre-frame, to receive the pre-frame from the AP.

S408. The STA performs listening on the first data channel based on the transmission information of the to-be-transmitted data, to receive the to-be-transmitted data from the AP.

It should be noted that, for a specific implementation process of each step in the method shown in FIG. 4, reference may be made to the specific implementation process in the foregoing method, and details are not described herein again. In addition, an execution order of steps S401 to S408 shown in FIG. 4 is not limited to the execution order shown in FIG. 4. For example, step S405 may be performed after step S401.

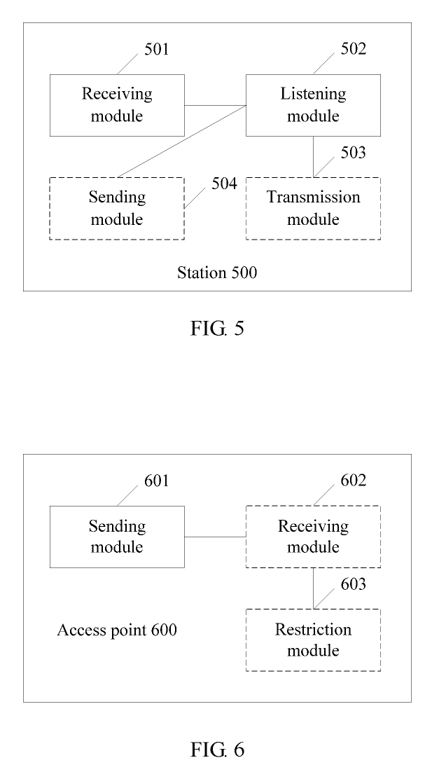

An embodiment of the present disclosure further provides a station (STA) 500. As shown in FIG. 5, the STA 500 includes:

a receiving module 501 configured to receive, on a first channel, a transmission indication from an access point (AP), where the transmission indication is used to indicate that a first frame is transmitted on a second channel, the transmission indication includes transmission information of the first frame, and the transmission information of the first frame includes at least one of a channel frequency, a channel bandwidth, spatial stream information, or a transmission time; and

a listening module 502 configured to perform listening on the second channel according to the transmission indication, to receive the first frame from the AP.

In one embodiment, when the first channel and the second channel are a same channel, and the first frame is data, duration for transmitting the first frame on the second channel is less than or equal to specified duration.

In one embodiment, before the receiving module 501 receives, on the first channel, the transmission indication from the AP,

the listening module 502 is further configured for the STA to perform listening on a third channel, to receive a second frame from the AP, where the second frame includes an indication of the first channel, the indication of the first channel includes characteristic information of the first channel, and the characteristic information of the first channel includes at least one of frequency of the first channel, bandwidth of the first channel, a sending time, a modulation scheme, a frame format, a protocol version, or a time period of the first channel; and

the receiving module 501 is configured to receive, on the first channel based on the characteristic information of the first channel, the transmission indication from the AP.

In one embodiment, the first frame is a trigger frame, the trigger frame includes an uplink transmission parameter, and after the listening module 502 performs listening on the second channel according to the transmission indication, to receive the first frame from the AP, the station further includes:

a transmission module 503 configured to perform uplink transmission based on the uplink transmission parameter, where the uplink transmission parameter includes at least one of a frequency, a bandwidth, a subchannel, a subcarrier, a time, a modulation and coding scheme, a MIMO spatial stream, or pilot resource information.

In one embodiment, before the receiving module 501 receives, on the first channel, the transmission indication from the AP,

the listening module 502 is further configured to perform listening on the second channel, to receive a third frame from the AP; and

the station further includes:

a sending module 504 configured to send a fourth frame to the AP on the second channel corresponding to the third frame, where the fourth frame includes a sending mode for sending the transmission indication, and the sending mode of the transmission indication is used by the AP to send the transmission indication, where

the sending mode of the transmission indication includes: sending the transmission indication on the first channel and/or sending the transmission indication on the second channel.

In one embodiment, the first frame includes transmission information of a fifth frame, the transmission information of the fifth frame includes at least one of a channel frequency, a channel bandwidth, spatial stream information, or a transmission time, and after the listening module 502 performs listening on the second channel according to the transmission indication, to receive the first frame from the AP,

the listening module 502 is further configured to perform listening on the second channel based on the transmission information of the fifth frame, to obtain the fifth frame.

In one embodiment, the transmission indication further includes a STA ID, a STA group ID, channel frequency information, or a channel number, and the listening module is specifically configured to: when the transmission indication meets a preset condition, perform listening on the second channel according to the transmission indication.

In one embodiment, before the listening module 502 performs listening on the second channel according to the transmission indication,

the listening module 502 is further configured to perform listening on the second channel, to receive a sixth frame from the AP, where the sixth frame is used to query a channel bandwidth available to the STA; and

the sending module 504 is further configured to send a seventh frame to the AP on the second channel corresponding to the sixth frame, where the seventh frame is used to return the channel bandwidth available to the STA, so that the AP sends the first frame on the channel bandwidth available to the STA.

It should be noted that the modules (e.g., the receiving module 501, the listening module 502, the transmission module 503, and the sending module 504) are configured to perform related steps in the foregoing method.

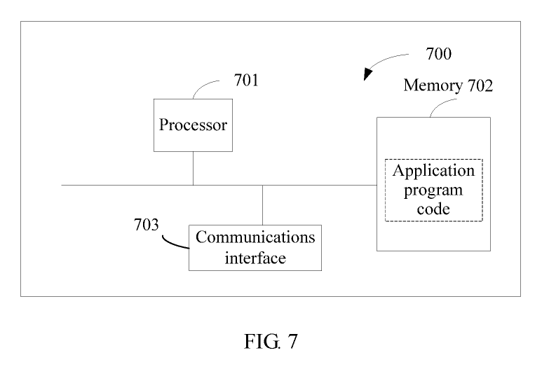

In this embodiment, the station 500 is presented in a form of a module. Herein, the “module” may be an application-specific integrated circuit (ASIC), a processor that executes one or more pieces of software or firmware programs, a memory, an integrated logic circuit, and/or another component that can provide the foregoing functions. In addition, the receiving module 501, the listening module 502, the transmission module 503, and the sending module 504 may be implemented by a processor 701 of a computer device shown in FIG. 7 by using a communications interface 703.

An embodiment of the present disclosure further provides an access point (AP) 600. As shown in FIG. 6, the AP 600 includes:

a sending module 601 configured to send a transmission indication on a first channel, where the transmission indication is used to indicate that a first frame is transmitted on a second channel, the transmission indication includes transmission information of the first frame, and the transmission information of the first frame includes at least one of a channel frequency, a channel bandwidth, spatial stream information, or a transmission time; and

the sending module 601 is further configured to send the first frame on the second channel according to the transmission indication.

In one embodiment, when the first channel and the second channel are a same channel, and the first frame is data, duration for transmitting the first frame on the second channel is less than or equal to specified duration.

In one embodiment, before the sending module 601 sends the transmission indication on the first channel,

the sending module 601 is further configured to send a second frame on a third channel, where the second frame includes an indication of the first channel, the indication of the first channel includes characteristic information of the first channel, and the characteristic information of the first channel includes at least one of frequency of the first channel, bandwidth of the first channel, a sending time, a modulation scheme, a frame format, a protocol version, or a time period of the first channel; and

the sending module 601 is configured to send the transmission indication on the first channel based on the characteristic information of the first channel.

In one embodiment, the first frame is a trigger frame, the trigger frame includes an uplink transmission parameter, and the uplink transmission parameter is used to instruct the STA to perform uplink transmission based on the uplink transmission parameter. The uplink transmission parameter includes at least one of a frequency, a bandwidth, a subchannel, a subcarrier, a time, a modulation and coding scheme, a MIMO spatial stream, and pilot resource information.

In one embodiment, before the sending module 601 sends the transmission indication on the first channel,

the sending module 601 is further configured to send a third frame on the second channel; and

the access point further includes:

a receiving module 602 configured to receive a fourth frame from the STA on the second channel corresponding to the third frame, where the fourth frame includes a sending mode for sending the transmission indication, and the sending mode of the transmission indication includes: sending the transmission indication on the first channel and/or sending the transmission indication on the second channel, where

the sending module 601 is configured to send the transmission indication on the first channel based on the sending mode of the transmission indication.

In one embodiment, the first frame includes transmission information of a fifth frame, the transmission information of the fifth frame includes at least one of a channel frequency, a channel bandwidth, spatial stream information, or a transmission time, and after the sending module 601 sends the first frame on the second channel according to the transmission indication,

the sending module 601 is further configured to send the fifth frame on the second channel based on the transmission information of the fifth frame.

In one embodiment, before the sending module 601 sends the first frame on the second channel according to the transmission indication,

the sending module 601 is further configured to send a sixth frame on the second channel, where the sixth frame is used to query a channel bandwidth available to the STA;

the receiving module 602 is further configured to receive a seventh frame from the STA to the AP on the second channel corresponding to the sixth frame, where the seventh frame is used to return the channel bandwidth available to the STA; and

the sending module 601 is configured to send, according to the transmission indication, the first frame on the channel bandwidth available to the STA.

In one embodiment, the first channel and the second channel are a same channel, and the access point further includes:

a restriction module 603 configured to: when the AP detects, on a channel used by the AP, a frame from another AP, restrict a type of a frame that is sent on the channel used by the AP.

In one embodiment, that duration for transmitting the first frame on the second channel is less than or equal to specified duration includes: duration for occupying the second channel by the first frame in a single physical transmission is less than or equal to first specified duration, and duration for occupying the second channel by the first frame in a single transmission is less than or equal to second specified duration. The second specified duration is greater than the first specified duration.

In one embodiment, a first frequency sub-band of the channel used by the AP and a second frequency sub-band of a channel used by the another AP belong to a same frequency band range.

It should be noted that the modules (e.g., the sending module 601, the receiving module 602, and the restriction module 603) are configured to perform related steps in the foregoing method.

In this embodiment, the access point 600 is presented in a form of a module. Herein, the “module” may be an ASIC, a processor that executes one or more pieces of software or firmware programs, a memory, an integrated logic circuit, and/or another component that can provide the foregoing functions. In addition, the restriction module 603 may be implemented by a processor 701 of a computer device shown in FIG. 7, and the sending module 601 and the receiving module 602 may be implemented by a communications interface 703 of the computer device shown in FIG. 7.

As shown in FIG. 7, the station 500 and the access point 600 may be implemented by using a structure in FIG. 7. The computer device 700 includes at least one processor 701, at least one memory 702, and at least one communications interface 703. The processor 701, the memory 702, and the communications interface 703 are connected and communicate with each other by using the communications bus.

The processor 701 may be a general purpose central processing unit (CPU), a microprocessor, an ASIC, or one or more integrated circuits for controlling execution of the foregoing solution program.

The communications interface 703 is configured to communicate with another device or communications network, such as the Ethernet, a radio access network (RAN), or a wireless local area network (WLAN).

The memory 702 may be a read-only memory (ROM) or another type of static storage device that may store static information and instructions, or a random access memory (RAM) or another type of dynamic storage device that may store information and instructions, or may be an electrically erasable programmable read-only memory (EEPROM), a compact disc read-only memory (CD-ROM), another optical disc storage medium, optical disc storage medium (including a compact disc, a laser disc, an optical disc, a digital versatile disc, a Blu-ray disc, or the like), or magnetic disk storage medium, another magnetic storage device, or any other medium that can be used to carry or store expected program code in a form of an instruction or a data structure and that can be accessed by a computer. This does not constitute a limitation herein. The memory may exist independently, and is connected to the processor by using the bus. The memory may alternatively be integrated with the processor.

The memory 702 is configured to store application program code for executing the foregoing solution, and the processor 701 controls the execution. The processor 701 is configured to execute the application program code stored in the memory 702.

When the computer device shown in FIG. 7 is a station, the code stored in the memory 702 may be used to execute the foregoing data transmission method executed by the station, for example, receive, on a first channel, a transmission indication from an AP, where the transmission indication is used to indicate that a first frame is transmitted on a second channel, the transmission indication includes transmission information of the first frame, and the transmission information of the first frame includes at least one of a channel frequency, a channel bandwidth, spatial stream information, or a transmission time; and perform listening on the second channel according to the transmission indication, to receive the first frame from the AP.

When the computer device shown in FIG. 7 is an access point, the code stored in the memory 702 may be used to execute the foregoing data transmission method executed by the access point, for example, send a transmission indication on a first channel, where the transmission indication is used to indicate that a first frame is transmitted on a second channel, the transmission indication includes transmission information of the first frame, and the transmission information of the first frame includes at least one of a channel frequency, a channel bandwidth, spatial stream information, or a transmission time; and send the first frame on the second channel according to the transmission indication.

An embodiment of the present disclosure further provides a computer storage medium, where the computer storage medium may store a program, and when the program is executed, some or all of the steps of any data transmission method described in the foregoing method embodiments are performed.

It should be noted that, to make the description brief, the foregoing method embodiments are expressed as a series of actions. However, a person skilled in the art should appreciate that the present disclosure is not limited to the described action sequence, because according to the present disclosure, some steps may be performed in other sequences or performed simultaneously. In addition, a person skilled in the art should also appreciate that all the embodiments described in the specification are examples of embodiments, and the related actions and modules are not necessarily mandatory to the present disclosure.

In the foregoing embodiments, the descriptions of the embodiments have respective focuses. For a part that is not described in detail in an embodiment, reference may be made to related descriptions in other embodiments.

In the several embodiments provided in this disclosure, it should be understood that the disclosed apparatuses may be implemented in other manners. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic or other forms.

The units described as separate parts may or may not be physically separate, and parts displayed as units may or may not be physical units, may be located in one position, or may be distributed on a plurality of network units. Some or all of the units may be selected based on actual needs to achieve the objectives of the solutions of the embodiments.

In addition, functional units in the embodiments of the present disclosure may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage. Based on such an understanding, the technical solutions of the present disclosure essentially, or the part contributing to the prior art, or all or a part of the technical solutions may be implemented in a form of a software product. The software product is stored in a storage and includes several instructions for instructing a computer device (which may be a personal computer, a server, a network device, or the like) to perform all or some of the steps of the methods described in the embodiments of the present disclosure. The storage includes any medium that can store program code, such as a Universal Serial Bus (USB) flash drive, a ROM, a RAM, a removable hard disk, a magnetic disk, or an optical disc.

A person of ordinary skill in the art may understand that all or some of the steps of the methods in the embodiments may be implemented by a program instructing relevant hardware. The program may be stored in a computer readable storage. The storage may include a flash memory, a ROM, a RAM, a magnetic disk, or an optical disc.

The embodiments of the present disclosure are described in detail above. The principle and implementations of the present disclosure are described herein through specific examples. The description about the embodiments of the present disclosure is merely provided to help understand the method and core ideas of the present disclosure. In addition, a person of ordinary skill in the art can make variations and modifications to the present disclosure in terms of the specific implementations and application scopes according to the ideas of the present disclosure. Therefore, the content of specification shall not be construed as limitation to the present disclosure.

What is claimed is:

1. A method for data transmission, comprising:
receiving, by a station (STA) on a first channel, a transmission indication from an access point (AP), wherein the transmission indication is used to indicate that a first frame is transmitted on a second channel, the transmission indication comprises transmission information of the first frame, and the transmission information of the first frame comprises at least one of a channel frequency, a channel bandwidth, spatial stream information, or a transmission time; and
listening, by the STA, on the second channel according to the transmission indication, to receive the first frame from the AP.

2. The method according to claim 1, wherein when the first channel and the second channel are a same channel and the first frame comprises data, duration for transmitting the first frame on the second channel is less than or equal to a specified duration.

3. The method according to claim 1, further comprising: before receiving the transmission indication from the AP,
listening, by the STA, on a third channel to receive a second frame from the AP, wherein the second frame comprises an indication of the first channel, the indication of the first channel comprises characteristic information of the first channel, and the characteristic information of the first channel comprises at least one of frequency of the first channel, bandwidth of the first channel, a sending time, a modulation scheme, a frame format, a protocol version, or a time period of the first channel; and
wherein receiving the transmission indication from the AP comprises: receiving, by the STA on the first channel based on the characteristic information of the first channel, the transmission indication from the AP.

4. The method according to claim 1, further comprising: before receiving the transmission indication sent by the AP,
listening, by the STA, on the second channel, to receive a third frame from the AP; and
sending, by the STA, a fourth frame to the AP on the second channel corresponding to the third frame, wherein the fourth frame comprises a sending mode for sending the transmission indication, and the sending mode for the transmission indication is used by the AP to send the transmission indication,
wherein the sending mode comprises: a first mode for sending the transmission indication on the first channel, or a second mode for sending the transmission indication on the second channel.

5. The method according to claim 1, wherein
the transmission indication further comprises a STA identifier (ID), a STA group ID, channel frequency information, or a channel number, and
listening on the second channel according to the transmission indication comprises: when the transmission indication meets a preset condition, listening, by the STA, on the second channel according to the transmission indication.

6. A method for data transmission, comprising:
sending, by an access point (AP), a transmission indication on a first channel to a station (STA), wherein the transmission indication is used to indicate that a first frame is transmitted on a second channel, the transmission indication comprises transmission information of the first frame, and the transmission information of the first frame comprises at least one of a channel frequency, a channel bandwidth, spatial stream information, or a transmission time; and
sending, by the AP, the first frame on the second channel according to the transmission indication to the STA.

7. The method according to claim 6, wherein when the first channel and the second channel are a same channel and the first frame comprises data, duration for transmitting the first frame on the second channel is less than or equal to a specified duration.

8. The method according to claim 6, further comprising: before sending the transmission indication on the first channel,
sending, by the AP, a second frame on a third channel, wherein the second frame comprises an indication of the first channel, the indication of the first channel comprises characteristic information of the first channel, and the characteristic information of the first channel comprises at least one of frequency of the first channel, bandwidth of the first channel, a sending time, a modulation scheme, a frame format, a protocol version, or a time period of the first channel; and
wherein sending the transmission indication on the first channel comprises: sending, by the AP, the transmission indication on the first channel based on the characteristic information of the first channel.

9. The method according to claim 6, further comprising: before sending the transmission indication on the first channel,
sending, by the AP, a third frame on the second channel;
receiving, by the AP, a fourth frame from the STA on the second channel corresponding to the third frame, wherein the fourth frame comprises a sending mode for sending the transmission indication, and the sending mode for the transmission indication comprises: a first mode for sending the transmission indication on the first channel, or a second mode for sending the transmission indication on the second channel; and
wherein sending the transmission indication on the first channel comprises: sending the transmission indication on the first channel based on the sending mode for the transmission indication.

10. The method according to claim 6, further comprising: before sending the first frame on the second channel according to the transmission indication,
sending, by the AP, a sixth frame on the second channel, wherein the sixth frame is used to query a channel bandwidth available to the STA;
receiving, by the AP, a seventh frame from the STA on the second channel corresponding to the sixth frame, wherein the seventh frame is used to return the channel bandwidth available to the STA; and
wherein sending the first frame on the second channel according to the transmission indication comprises: sending, by the AP according to the transmission indication, the first frame on the channel bandwidth available to the STA.

11. A station comprising a memory, a processor, and a communications interface, wherein the memory is configured to store executable program code, and the processor invokes the executable program code stored in the memory to:
receive, on a first channel by using the communications interface, a transmission indication from an access point (AP), wherein the transmission indication is used to indicate that a first frame is transmitted on a second channel, the transmission indication comprises transmission information of the first frame, and the transmission information of the first frame comprises at least one of a channel frequency, a channel bandwidth, spatial stream information, or a transmission time; and
listen on the second channel according to the transmission indication to receive the first frame from the AP.

12. The station according to claim 11, wherein when the first channel and the second channel are a same channel and the first frame comprises data, duration for transmitting the first frame on the second channel is less than or equal to a specified duration.

13. The station according to claim 11, wherein before receiving the transmission indication from the AP,
the processor is further configured to:
listen on a third channel by using the communications interface,
receive a second frame from the AP, wherein the second frame comprises an indication of the first channel, the indication of the first channel comprises characteristic information of the first channel, and the characteristic information of the first channel comprises at least one of frequency of the first channel, bandwidth of the first channel, a sending time, a modulation scheme, a frame format, a protocol version, or a time period of the first channel; and
wherein to receive the transmission indication from the AP, the processor is configured to receive, on the first channel based on the characteristic information of the first channel by using the communications interface, the transmission indication sent by the AP.

14. The station according to claim 11, wherein before receiving the transmission indication from the AP,
the processor is further configured to:
listen on the second channel by using the communications interface,
receive a third frame from the AP; and
send a fourth frame to the AP on the second channel corresponding to the third frame, wherein the fourth frame comprises a sending mode for sending the transmission indication, the sending mode for the transmission indication is used by the AP to send the transmission indication, and the sending mode for the transmission indication comprises: a first mode for sending the transmission indication on the first channel, or a second mode for sending the transmission indication on the second channel.

15. The station according to claim 11, wherein the transmission indication further comprises a STA identifier (ID), a STA group ID, channel frequency information, or a channel number, and
wherein to listen on the second channel, the processor is configured to: listen on the second channel according to the transmission indication by using the communications interface when the transmission indication meets a preset condition.

16. An access point comprising a memory, a processor, and a communications interface, wherein the memory is configured to store executable program code, and the processor invokes the executable program code stored in the memory to:
send a transmission indication on a first channel by using the communications interface to a station (STA), wherein the transmission indication is used to indicate that a first frame is transmitted on a second channel, the transmission indication comprises transmission information of the first frame, and the transmission information of the first frame comprises at least one of a channel frequency, a channel bandwidth, spatial stream information, or a transmission time; and
send the first frame on the second channel according to the transmission indication to the STA.

17. The access point according to claim 16, wherein when the first channel and the second channel are a same channel and the first frame comprises data, duration for transmitting the first frame on the second channel is less than or equal to a specified duration.

18. The access point according to claim 16, wherein before sending the transmission indication on the first channel by using the communications interface,
the processor is further configured to:
send a second frame on a third channel by using the communications interface, wherein the second frame comprises an indication of the first channel, the indication of the first channel comprises characteristic information of the first channel, and the characteristic information of the first channel comprises at least one of frequency of the first channel, bandwidth of the first channel, a sending time, a modulation scheme, a frame format, a protocol version, or a time period of the first channel; and
wherein to send the transmission indication on the first channel, the processor is configured to send the transmission indication on the first channel based on the characteristic information of the first channel by using the communications interface.

19. The access point according to claim 16, wherein before sending the transmission indication on the first channel by using the communications interface,
the processor is further configured to:
send a third frame on the second channel by using the communications interface; and
receive a fourth frame from the STA on the second channel corresponding to the third frame, wherein the fourth frame comprises a sending mode for sending the transmission indication, and the sending mode for the transmission indication comprises: a first mode for sending the transmission indication on the first channel, or a second mode for sending the transmission indication on the second channel; and
wherein to send the transmission indication on the first channel, the processor is configured to send the transmission indication on the first channel based on the sending mode for the transmission indication by using the communications interface.

20. The access point according to claim 16, wherein before sending the first frame on the second channel according to the transmission indication by using the communications interface,
the processor is further configured to:
send a sixth frame on the second channel by using the communications interface, wherein the sixth frame is used to query a channel bandwidth available to the STA; and
receive a seventh frame from the STA to the AP on the second channel corresponding to the sixth frame, wherein the seventh frame is used to return the channel bandwidth available to the STA; and
wherein to send the first frame on the second channel, the processor is configured to send, according to the transmission indication by using the communications interface, the first frame on the channel bandwidth available to the STA.
